(19) United States
(12) Patent Application Publication
(10) Pub. No.: US 2003/0063207 A1
(43) Pub. Date: Apr. 3, 2003

(54) Imaging apparatus with drain control of unnecessary charges

(76) Inventors: Yoshimitsu Noguchi, Gifu-ken (JP); Hiroyuki Yamase, Ichinomiya-shi (JP)

Correspondence Address: FISH & RICHARDSON PC, 225 FRANKLIN ST, BOSTON, MA, 02110, US

(21) Appl. No.: 10/261,398

(22) Filed: Oct. 1, 2002

(30) Foreign Application Priority Data
Oct. 2, 2001 (JP) 2001-306194

(51) Int. Cl. H04N 3/14

(52) U.S. Cl. 348/312; 348/207.1

(57) ABSTRACT

An imaging apparatus includes a solid-state imaging device for generating an image signal. The solid-state imaging device includes light receiving pixels for accumulating information charges. Vertical shift registers transfer the information charges accumulated in the light receiving pixels when receiving a cyclic vertical drive signal. A horizontal shift register outputs the information charges received from the vertical shift registers when receiving a horizontal drive signal. Unnecessary charges stored in the horizontal shift register are drained during at least part of a period in which the output of the image signal is interrupted and the output interruption period is relatively long to prevent the image quality from deteriorating.

### BACKGROUND OF THE INVENTION

The present invention relates to an imaging apparatus, and more particularly, to an imaging apparatus that provides image information to an external device.

A system including an imaging apparatus, which uses a solid-state imaging device, and an external device such as a computer that is connected to the imaging apparatus, is known in the prior art. In the system, image information, which is generated by the imaging apparatus, is provided to the external device, which operates asynchronously with the imaging apparatus. In recent years, there are cellular phones that incorporate imaging apparatuses, which are used as digital cameras. In such case, image information is provided from the imaging apparatus to a controller of the cellular phone.

FIG. 1 is a schematic block diagram of a prior art imaging apparatus 100, which is incorporated in an external device, such as a computer or a cellular phone. FIG. 2 is a timing chart illustrating the operation of the imaging apparatus 100. The CCD image sensor 1 is, for example, a frame transfer type solid-state imaging device, and includes an imaging section 1i, an accumulating section 1s, a horizontal transfer section 1h, and an output section 1d.

The imaging section 1i includes a plurality of parallel vertical shift registers 1i0-1in. Each shift register has a plurality of register bits, each of which forms a light receiving pixel. Each light receiving pixel performs photoelectric conversion in response to an irradiated subject image to generate information charges and accumulate the information charges.

The accumulating section 1s includes a plurality of vertical shift registers 1so-1sn, which are formed continuously with the vertical shift registers 1i0-1in. The bit number of each vertical shift register 1so-1sn is the same as the bit number of each vertical shift register 1i0-1in. The accumulating section is receives information charges, which correspond to a single screen image and are simultaneously transferred from the imaging section 1i, and temporarily accumulates the information charges.

The horizontal transfer section 1h is a single horizontal shift register, which is connected to the vertical shift registers 1so-1sn of the accumulating section 1s. The horizontal shift register has a plurality of register bits that are associated with the vertical shift registers 1so-1sn. The horizontal transfer section 1h receives information charges corresponding to a single screen image from the accumulating section 1s in units of single horizontal lines and sequentially horizontally transfers the information charges of a single line. The output section 1d is connected to the horizontal transfer section 1h and has a capacitor that stores the information charges from the horizontal transfer section 1h in single pixel units. The output section Id converts the information charges stored in the capacitor to voltage to generate an image signal Y(t).

As shown in FIG. 1, the imaging apparatus 100 includes a CCD driver circuit 2, an analog signal processing circuit 3, an A/D conversion circuit 4, a digital signal processing circuit 5, an interface control circuit 6, a memory control circuit 7, a line memory 8, a command register 9, and a timing control circuit 10.

The CCD driver circuit 2 receives a frame shift timing signal FT, a line feed timing signal VT, a horizontal transfer timing signal HT, and a drain timing signal BT from the timing control circuit 10. The timing control circuit 10 also generates a frame transfer clock signal of, a vertical transfer clock signal øv, a horizontal transfer clock signal øh, and a drain clock signal øb.

The frame transfer clock signal øf is generated in accordance with a timing determined by the frame shift timing signal FT and has, for example, a four phase clock pulse. The information charges, which correspond to a single screen image and which are accumulated in the imaging section 1i, are transferred to the accumulating section is at a high speed in accordance with the frame transfer clock signal øf. The vertical transfer clock signal øv is generated at a timing that is in accordance with the line feed timing signal VT and has, for example, a four phase clock pulse. The information charges, which correspond to a single screen image, are accumulated in the accumulating section is, and are transferred to the horizontal transfer section 1b in single horizontal line units. The horizontal transfer clock signal øh is generated at a timing that is in accordance with the horizontal transfer timing signal HT and has, for example, a two phase clock pulse. Information charges corresponding to a single horizontal line are sequentially transferred in the horizontal direction in accordance with the horizontal transfer clock signal øh.

The drain clock signal øb is used to drain the charges accumulated in the imaging section 1i. If the CCD image sensor 1 has a vertical overflow drain configuration, the drain clock signal øb is applied to the substrate of the CCD image sensor 1. If the CCD image sensor 1 has a horizontal overflow drain configuration, the drain clock signal øb is applied to an overflow drain area. The accumulating period of information charges in the imaging section 1i corresponds to a period L from when the drain clock signal øb goes high to when the frame transfer clock signal of is generated. The providing timing of the drain clock signal øb is determined in accordance with the integral value of the image signal, which is output from the CCD image sensor 1. That is, after an analog image signal is converted to a digital image signal, the digital image signal is integrated in single screen image units, or units of given periods. When the integral data signal becomes greater than an appropriate value, the timing of providing of the drain clock signal øb is delayed to shorten the accumulation period. When the integral data signal becomes less than the appropriate value, the timing of providing of the drain clock signal øb is advanced to lengthen the accumulation period. Accordingly, feedback control is performed so that the CCD image sensor 1 is maintained in an appropriate exposure state.

The analog signal processing circuit 3 performs an analog signal process, such as correlated double sampling (CDS) and automatic gain control (AGC), on the image signal Y(t) output from the CCD image sensor 1. In the CDS, for a image signal Y(t), which repeats a signal level and a reset level, the signal level is clamped after the reset level is clamped. Then, the difference between the clamped reset level and the clamped signal level is extracted to generate an image signal having a continuous signal level. In the AGC, the CDS processed image signal is integrated in single screen image units or signal vertical scan period units to perform gain feedback control so that the integrated data signal is included in a predetermined range. The A/D converter 4 formats the image signal Y(t) in synchronism with the operating timing of the CCD image sensor 1 to generate the digital image data signal Y(n).

The digital signal processing circuit 5 performs digital signal processing, such as color separation and matrix calculation to generate an image data signal D(n), which includes luminance data and chrominance data. For example, when performing color separation, the image data signal Y(n) is separated in accordance with the color array of the color filter attached to the imaging section 1i of the CCD image sensor 1 to generate a plurality of color component data signals R(n), G(n), B(n). Further, when performing matrix calculation, each generated color component data signal is synthesized at a predetermined ratio to generate the luminance data signal. Further, the luminance data signal is subtracted from the color component data signals R(n), G(n) to generate a chrominance data signal.

The digital signal processing circuit 5 incorporates the interface control circuit 6 and the memory control circuit 7. The interface control circuit 6 receives a read state signal HREF from the memory control circuit 7 via a control bus 50 and provides the read state signal HREF to the external device. The interface control circuit 6 receives a read clock signal EXCLK from the external device and provides the read clock signal EXCLK to the memory control circuit 7. The interface control circuit 6 is connected to a data bus 51 to transfer data between the external device and the imaging apparatus.

The memory control circuit 7 controls the writing of data to the line memory 8 and the reading of data from the line memory 8. The memory control circuit 7 generates the read state signal HREF in accordance with the state of the data stored in the line memory 8. That is, when the color component data signals R(n), G(n), B(n) corresponding to a single horizontal line are stored in the line memory 8, the read state signal HREF goes high. When the read state signal HREF goes high, permission is given to the external device to receive data from the line memory 8. The external device generates the read clock signal EXCLK for instructing the reading of data in response to the read state signal HREF and provides the memory control circuit 7 with the read clock signal EXCLK. The external device receives the data signal read from the line memory 8 via the interface control circuit 6. The memory control circuit 7 causes the read state signal HREF to go low when the reading of data from the line memory 8 ends. During the period the read state signal HREF is low, the external device is not allowed to receive data from the line memory 8.

To adjust the timing for reading data from the external device and the output timing of the image signal Y(t) from the CCD image sensor 1, the memory control circuit 7 also provides the read state signal HREF to the timing control circuit 10. That is, the output of the image signal from the CCD image sensor 1 is permitted only when the read state signal is low, and the data signal of the next horizontal line is retrieved by the digital signal processing circuit 5 when the reading of data from the line memory 8 ends. The command register 9 stores various commands provided from the external device and determines the processing conditions of the digital signal processing circuit 5.

The timing control circuit 10 receives a vertical synchronizing signal VD, a horizontal synchronizing signal HD, and the read state signal HREF, which is provided from the memory control circuit 7, and generates various timing signals. The timing control circuit 10 generates a frame timing signal FT, which determines the timing for transferring information charges from the imaging section 1i to the accumulating section Is. Further, the timing control circuit 10 generates a drain timing signal FT in response to a drain command from the digital signal processing circuit 5. When the read state signal HREF goes low, the timing control circuit 3 generates the line feed timing signal VT, which determines the timing for feeding a line of information charges from the accumulating section 1s to the horizontal transfer section 1h. The timing control circuit 10 also generates a horizontal transfer timing signal HT, which determines the timing for horizontally transferring information charges by the horizontal transfer section 1h.

As described above, the imaging apparatus 100 controls the CCD image sensor 1. As a result, the image signals corresponding to a single horizontal line is continuously output from the CCD image sensor 1. The image signals are processed and then stored in the line memory 8. The external device provides a clock pulse signal to the imaging apparatus 100 and retrieves the image data signal when necessary. In such imaging apparatus 100, the image data may not be immediately read if a large load is applied to the external device when the external device is performing other processes. For example, when the imaging apparatus 100 is installed in a cellular phone and the cellular phone receives a phone call, a controller (e.g., central processing unit (CPU)), which controls the entire cellular phone give priority to the processing of the received call regardless of the imaging operation. As a result, the operation of the CCD image sensor 1 is stopped during the priority processing period even when the CCD image sensor 1 is outputting the image signal of a single screen image. Thus, when the controller performs a process other than the imaging operation, the imaging apparatus 100 is maintained in a standby state for a long period of time.

When the external device causes the imaging apparatus 100 to remain in the standby state for a long period of time, dark current generates charges in each shift register of the CCD image sensor 1. The charges, which are unnecessary, are accumulated in each shift register of the CCD image sensor 1. When information charges are transferred from the vertical shift register to the horizontal shift register, which is accumulating unnecessary charges, unnecessary charges are added to the information charges. This deteriorates the image quality. Further, if the period during which the output of the information charges is interrupted is significantly long, the unnecessary charges saturate the horizontal shift register, and the horizontal shift register cannot properly receive the information charges output from the vertical shift register. This destroys the image information. As a result, noise appears on a reproduced screen image as a pale straight line in which the output is interrupted.

### SUMMARY OF THE INVENTION

An aspect of the present invention is an imaging apparatus that prevents the image quality from deteriorating even if the output interruption period of information charges from the horizontal shift register is relatively long.

The present invention provides an imaging apparatus including a solid-state imaging device for generating an image signal in accordance with a subject image and providing the image signal to an external device. The solid-state imaging device includes a plurality of light receiving pixels arranged in a matrix form, for accumulating information charges. A plurality of vertical shift registers transfers the information charges accumulated in the light receiving pixels in a vertical direction. A horizontal shift register receives the information charges from the vertical shift registers and outputs the information charges in single line units. A drive circuit is connected to the solid-state imaging device to provide the vertical shift registers with a vertical drive signal and the horizontal shift register with a horizontal drive signal to generate the image signal in the solid-state imaging device. A timing control circuit is connected to the drive circuit to control the drive circuit to provide the vertical shift registers with the vertical drive signal at a constant cycle and provide the horizontal shift register with the horizontal drive signal in accordance with an output request of the image signal from the external device. The timing control circuit controls the drive circuit to provide the horizontal shift register with the horizontal drive signal and to drain unnecessary charges stored in the horizontal shift register during at least part of a period in which the output of the image signal is interrupted from when the providing of the image signal that corresponds to a single line is completed to when the output request is subsequently received from the external device.

A further perspective of the present invention is an imaging apparatus including a solid-state imaging device for generating an image signal in accordance with a subject image and providing the image signal to an external device, The solid-state imaging device includes a plurality of light receiving pixels arranged in a matrix form, for accumulating information charges. A plurality of vertical shift registers transfer the information charges accumulated in the light receiving pixels in a vertical direction. A horizontal shift register receives the information charges from the vertical shift registers and outputs the-information charges in single line units. A drive circuit is connected to the solid-state imaging device to provide the vertical shift registers with a vertical drive signal and the horizontal shift register with a horizontal drive signal to generate the image signal in the solid-state imaging device. A timing control circuit is connected to the drive circuit to control the drive circuit to provide the vertical shift registers with the vertical drive signal at a constant cycle and provide the horizontal shift register with the horizontal drive signal in accordance with an output request of the image signal from the external device. A clamp circuit clamps the level of the image signal at a predetermined reference level, The timing control circuit controls the drive circuit to provide the horizontal shift register with the horizontal drive signal and to drain unnecessary charges stored in the horizontal shift register during at least part of a period in which the output of the image signal is interrupted from when the providing of the image signal that corresponds to a single line is completed to when the output request is subsequently received from the external device.

The timing control circuit controls the drive circuit to further provide the horizontal shift register with the horizontal drive signal after draining of the charges is completed to drive the empty horizontal shift register. The clamp circuit clamps the image signal during at least part of the period in which the empty horizontal shift register is driven.

A further perspective of the present invention is a method for driving a solid-state imaging device that generates an image signal in accordance with a subject image and provides the image signal to an external device. The solid-state imaging device includes a plurality of light receiving pixels, which are arranged in a matrix form, for accumulating information charges, a plurality of vertical shift registers, and a horizontal shift register. The method includes transferring the information charges accumulated in the light receiving pixels in a vertical direction by providing the vertical shift registers with a vertical drive signal at a constant cycle, outputting the information charges transferred from the vertical shift registers in single line units by providing the horizontal shift register with a horizontal drive signal in accordance with an output request of the image signal from an external device, generating the image signal in accordance with the information charges and providing the image signal to the external device in single line units, and draining unnecessary charges stored in the horizontal shift register by providing the horizontal shift register with the horizontal drive signal during at least part of a period in which the output of the image signal is interrupted from when the providing of the image signal that corresponds to a single line is completed to when an output request is subsequently received from the external device.

A further perspective of the present invention is a method for driving a solid-state imaging device that generates an image signal in accordance with a subject image and provides the image signal to an external device. The solid-state imaging device includes a plurality of light receiving pixels, arranged in a matrix form, for accumulating information charges, a plurality of vertical shift registers, and a horizontal shift register. The method includes transferring the information charges accumulated in the light receiving pixels in a vertical direction by providing the vertical shift registers with a vertical drive signal at a constant cycle, outputting the information charges transferred from the vertical shift registers in single line units by providing the horizontal shift register with a horizontal drive signal in accordance with an output request of the image signal from an external device, generating the image signal in accordance with the information charges and providing the image signal to the external device in single line units, draining unnecessary charges stored in the horizontal shift register by providing the horizontal shift register with the horizontal drive signal during at least part of a period in which the output of the image signal is interrupted from when the providing of the image signal that corresponds to a single line is completed to when an output request is subsequently received from the external device, driving the empty horizontal shift register after the draining step by providing the horizontal shift register with the horizontal drive signal, and clamping the level of the image signal at a predetermined reference level during at least part of the period in which the empty horizontal shift register is driven.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with advantages thereof, may best be understood by reference to the following description of the presently preferred embodiments together with the accompanying drawings in which:

FIG. 1 is a schematic block diagram of a prior art imaging apparatus;

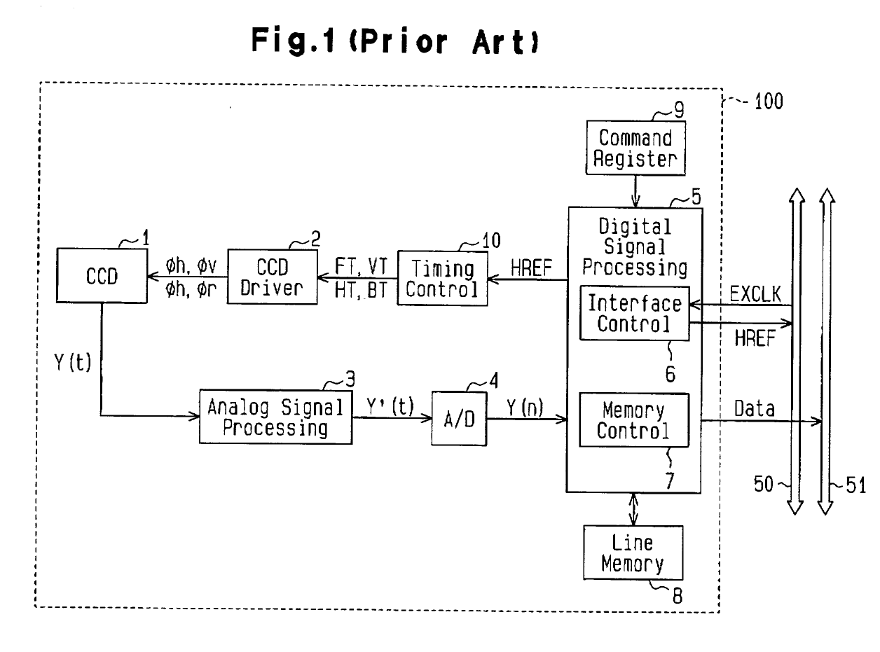

FIG. 2 is a timing chart illustrating the operation of the imaging apparatus of FIG. 1;

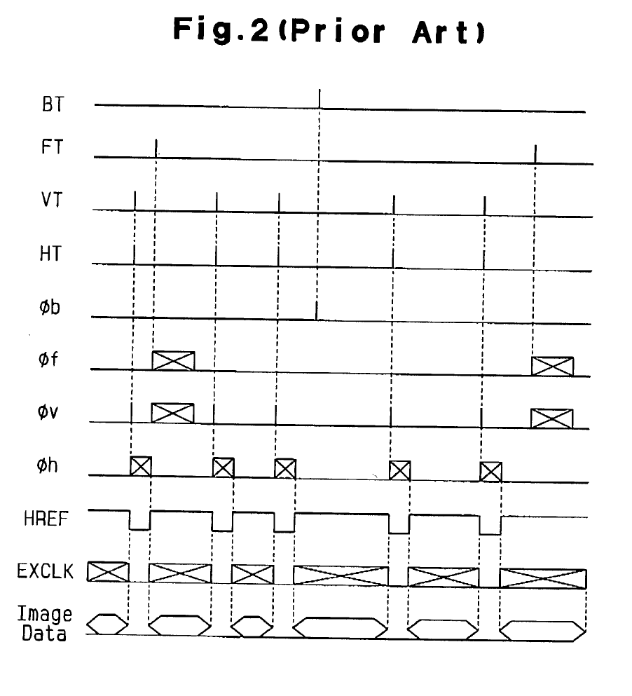

FIG. 3 is a plan view showing a CCD image sensor incorporated in the imaging apparatus of FIG. 2;

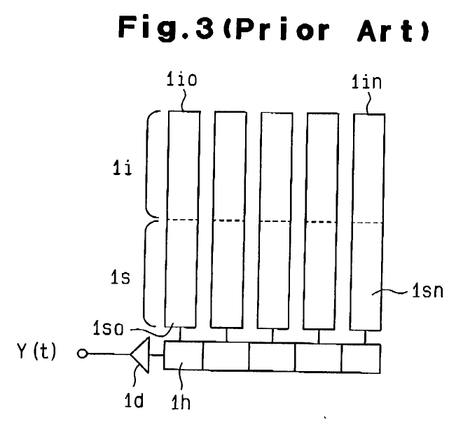

FIG. 4 is a schematic block diagram illustrating an imaging apparatus according to a first embodiment of the present invention;

FIG. 5 is a timing chart illustrating the operation of the imaging apparatus of FIG. 4;

FIG. 6 is a schematic circuit diagram showing part of an imaging apparatus according to a second embodiment of the present invention; and

FIG. 7 is a timing chart illustrating the operation of the imaging apparatus of FIG. 6.

### DETAILED DESCRIPTION OF THE PREFERRED EMBODIMENTS

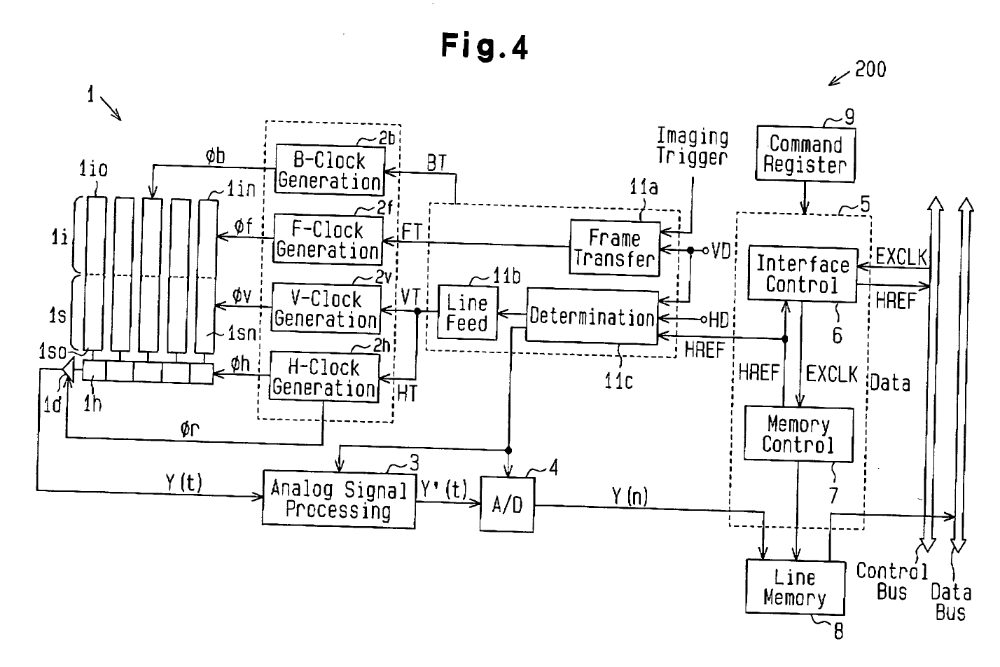

In the drawings, like numerals are used for like elements throughout. FIG. 4 is a schematic block diagram of an imaging apparatus 200 according to a first embodiment of the present invention. The imaging apparatus 200 includes a CCD image sensor 1, a CCD driver circuit 2, an analog signal processing circuit 3, an A/D conversion circuit 4, a digital signal processing circuit 5, and a timing control circuit The feature of the imaging apparatus 200 according to the present invention is in that a horizontal transfer section 1h is driven during at least part of the output interruption period in which the output of an image signal is interrupted from when the output signal corresponding to a single line ends to when the external device requests the output of the next image signal. In other words, when the external device causes the output of the image signal from the CCD image sensor 1 to be interrupted, the horizontal transfer section 1h is driven during at least part of the output interruption period to drain unnecessary charges, which are produced by dark currents and collected in the horizontal transfer section 1h, from the horizontal transfer section 1h.

The CCD image sensor 1 is, for example, a frame transfer type solid-state imaging device and includes an imaging section 1i, an accumulating section is, the horizontal transfer section 1h, and an output section 1d. The imaging section 1i includes a plurality of vertical shift registers 1io-1in. Each vertical shift register includes a plurality of register bits, each of which configures a light receiving pixel. The vertical shift registers 1io-1in are arranged parallel to each other. Thus, a plurality of light receiving pixels are arranged as a matrix. Some of vertical shift registers 1io-1in are shaded. The shaded area is defined as an optical black (OPB) area.

The accumulating section Is includes a plurality of vertical shift registers 1s0-1sn, which are formed continuously with the vertical shift registers 1io-1in. The horizontal transfer section 1h is a single horizontal shift register connected to the vertical shift registers 1s0-1sn. The output section 1d includes a capacitor connected to the horizontal transfer section 1h.

The CCD driver circuit 2 includes a B-clock generation circuit 2b, an F-clock generation circuit 2f, a V-clock generation circuit 2v, and an H-clock generation circuit 2h. The B-clock generation circuit 2b generates a drain clock signal øb in response to a drain timing signal BT provided from the timing control circuit 11 and provides the drain clock signal øb to the imaging section 1i. This simultaneously drains the information charges accumulated in the imaging section 1i in accordance with a drain timing that is set by the timing control circuit 11.

The F-clock generation circuit 2f generates a four phase frame transfer clock signal øf in response to a frame timing signal FT, which is provided from the timing control circuit 11, and provides the frame transfer clock signal øf to the imaging section 1i. The V-clock generation circuit 2v generates a four phase vertical transfer clock signal øv in response to a line feed timing signal VT, which is provided from the timing control circuit 11, and provides the vertical transfer clock signal øv to the accumulating section 1s. The H-clock generation circuit 2h generates a two phase horizontal transfer clock signal øh in response to a horizontal transfer timing signal HT, which is provided from the timing control circuit 11, and provides the horizontal transfer clock signal øh to the horizontal transfer section 1h. Further, the H-clock generation circuit 2h generates a two phase reset clock signal ør in response to the horizontal transfer timing signal HT and provides the reset clock signal ør to the output section 1d. These clock signals transfer the information charges corresponding to a single screen image accumulated in the imaging section 1i to the accumulating section 1s at a high speed and temporarily accumulates the information charges in the accumulating section 1s. The information charges accumulates in the accumulating section 1s are transferred to the horizontal transfer section 1h in single horizontal line units. The information charges are then transferred from the horizontal transfer section 1h to the output section 1d. An image signal Y(t) is output from the output section id.

The analog signal processing circuit 3 receives the image signal Y(t) from the CCD image sensor 1 and performs an analog signal processing, such as CDS and ACC, on the image signal Y(t), to generate an analog image signal Y′(t). The analog signal processing circuit 3 includes a clamp circuit (not shown) for clamping the image signal Y(t). The clamp circuit clamps the voltage of the image signal Y(t) corresponding to the OPB area at a predetermined clamp voltage to obtain the same black level (zero level) in each line and screen image. The A/D conversion circuit 4 formats the image signal Y′(t) in synchronism with the operation timing of the CCD image sensor 1 and converts the analog image signal Y′(t) to a digital image data signal Y(n).

The digital signal processing circuit 5 performs processing on the image data signal Y(n), such as color separation and matrix calculation to generate color component data signals R(n), G(n), B(n). The digital signal processing circuit 5 includes an interface control circuit 6, which transfers control signals and data signals between an external device and the imaging apparatus 200, and a memory control circuit 7, which controls the writing of data to the line memory 8 and the reading of data from the line memory 8.

The interface control circuit 6 receives a read state signal HREF from the memory control circuit 7 and provides the read state signal HREF to the external device. Further, the interface control circuit 6 receives a read clock signal EXCLK, which represents an image output request, from the external device and provides the read clock signal EXCLK to the memory control circuit 7.

The memory control circuit 7 controls the writing of data to the line memory 8 and the reading of data from the line memory 8. The memory control circuit 7 generates the read state signal HREF in accordance with the control of the line memory 8. More specifically, when the color component data signals R(n), G(n), B(n), which are generated through the color separation process and correspond to a single horizontal line, are written to the line memory 8, the read state signal HREF goes high and permission is given to the external device to receive data from the line memory 8. Accordingly, as long as the writing of data to the line memory 8 is completed, the external device reads data at its preferable timing.

The memory control circuit 7 provides the read state signal HREF to the timing control circuit 11 and controls the operation timing of the CCD image sensor 1 in accordance with the state of the line memory 8. More specifically, the memory control circuit 7 causes the read state signal HREF to go low when the reading of the data stored in the line memory 8 ends and permits the output of the image signal Y(t) from the CCD image sensor 1 as long as the read state signal HREF is low.

The command register 9 stores various commands provided from the external device and determines the processing conditions of the digital signal processing circuit 5.

The timing control circuit 11 includes a frame transfer control circuit 11a, a line feed control circuit 11b, and a determination circuit 11c. The timing control circuit 11 determines the operation timing of the CCD image sensor 1 in accordance with the state of the read state signal HREF (i.e., the data read state in the external device). The frame transfer control circuit 11a determines the timing for vertically transferring the information charges of the imaging section 1i in the CCD image sensor 1 to the accumulating section 1s. That is, the frame transfer control circuit 11a receives a vertical synchronizing signal VD and an imaging trigger signal, which is provided from the external device, and generates a frame timing signal FT, which is provided to the F-clock generation circuit 2f. In the NTSC technique, the vertical synchronizing signal VD is generated by dividing a horizontal synchronizing signal HD by 2/525. The vertical synchronizing signal HD is generated by dividing a reference clock signal having a frequency of 14.32 MHz, which is four times the frequency of a color subcarrier (3.58 MHz) that is used in the signal processing stage, by 1/910. When the entire device including the imaging apparatus is instructed to perform imaging, the imaging trigger signal is provided from the external device to the imaging apparatus 200 to designate the timing for starting imaging.

The line feed control circuit 11b determines the timing for transferring the information charges accumulated in the accumulating section Is to the horizontal transfer section 1h. The line feed control circuit 11b generates the line feed timing signal VT and the horizontal transfer timing signal HT and provides the line feed timing signal VT and the horizontal transfer timing signal HT to the V-clock generation circuit 2v and the H-clock generation circuit 2h, respectively. The line feed control circuit 11b operates in response to an instruction from the determination circuit 11c and activates the V-clock generation circuit 2v and the H-clock generation circuit 2h.

When the read state signal HREF is high, the determination circuit 11c counts the horizontal synchronizing signal HD and compares an optimal value, which is the count value, with a predetermined determination reference value. Based on the comparison result, the determination circuit 11c determines whether or not the output interruption period of the image signal Y(t) from the CCD image sensor 1 is greater than a predetermined period. The determination circuit 11c controls the timing for providing the line teed timing signal VT and the horizontal transfer timing signal HT based on the determination result. More specifically, when the count value is greater than or equal to the determination reference value, the determination circuit 11c provides the line feed control circuit 11b with a control signal so that the line feed timing signal VT goes high at a later time and the horizontal transfer timing signal HT temporarily goes high before the line feed timing signal VT goes high. In other words, the horizontal transfer section 1h is driven during the period from when the output of the information charges of the line that is just before the output interruption of the image signal Y(t) is interrupted to when the output of the information charges of the next horizontal line is started. By performing such control, the unnecessary charges collected in the horizontal transfer section 1h during the output interruption period of the image signal Y(t) are drained before information charges are transferred from the accumulating section 1s to the horizontal transfer section 1h. For example, when the determination reference value is set at 50 to 150 and a single cycle of the horizontal synchronizing signal HD is defined as 1H, the determination reference period is set at 50H to 150H. The determination reference value is stored as a default value in a register (not shown) of the timing control circuit 11 and may be changed by a command from the external apparatus.

When the count value is less than the determination reference value, the determination circuit 11c does not drain unnecessary charges and provides the line feed control circuit 11b with a control signal so that the line teed timing signal VT and the horizontal transfer timing signal HT go high after the read state signal HREF goes low in the normal manner. In this case, the information charges corresponding to a single horizontal line are transferred from the accumulating section 1s to the horizontal transfer section 1h in accordance with the vertical transfer clock signal øv and the horizontal transfer clock signal øh, and the information charges are sequentially transferred from the horizontal transfer section 1h to the output section 1d The determination circuit 11c resets the count value whenever the read state signal HREF goes low and performs the determination operation when the read state signal HREF is high.

Based on the determination result of the determination circuit 11c, the timing control circuit 11 recognizes the timing at which the image signal corresponding to the information charges from the CCD image sensor 1 is output and the timing at which the output signal corresponding to unnecessary charges is output. When the output signal corresponding to unnecessary charges is output, the timing control circuit 11 provides the analog signal processing circuit 3 and the A/D conversion circuit 4 with a control signal that stops the operation of the analog signal processing circuit 3 and the A/D conversion circuit 4. Such control prevents signals of unnecessary charges from being included in the connection line downstream to the analog signal processing circuit 3 or the A/D conversion circuit 4.

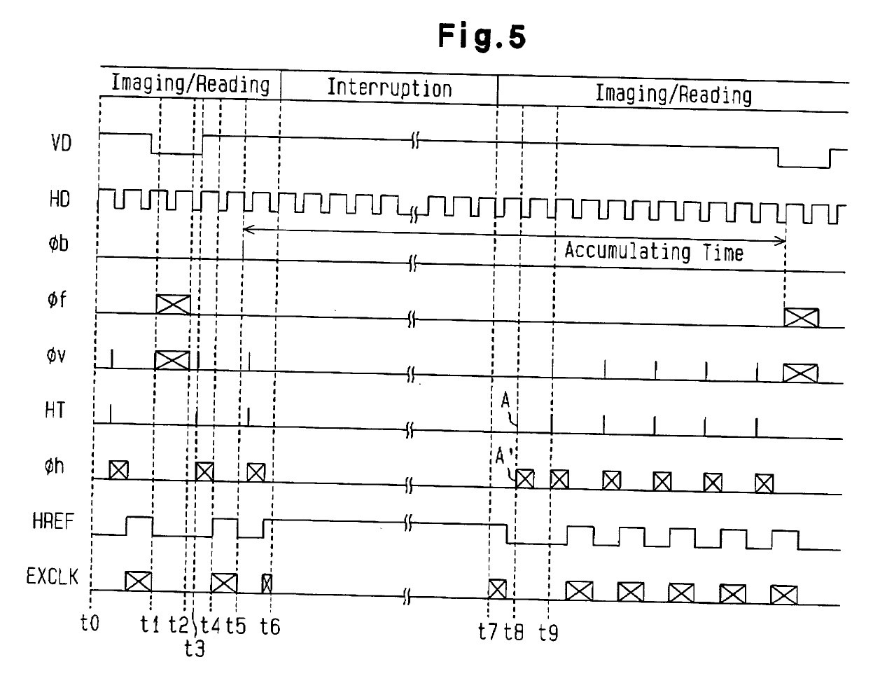

The operation of the imaging apparatus 200 will now be discussed with reference to the timing chart of FIG. 5. A controller, which controls the entire device including the imaging apparatus 200, performs processes corresponding to the imaging and reading operations after timing t0 and performs an interruption process during timing t6 to timing t7. The interruption process is given priority over other processes. Further, the optimal value of the determination circuit 11c is 100H.

First, during the period between timing t1 and timing t2, the frame transfer clock of and the vertical transfer clock øv are generated, and the information charges accumulated in the imaging section 1i are transferred to the accumulating section 1s. Then, at timing t3, the vertical transfer clock signal øv goes high. Further, the horizontal transfer timing signal HT goes high and starts the generation of the horizontal transfer clock signal øh. The horizontal transfer clock signal øh causes information charges corresponding to a single horizontal line to be sequentially transferred from the horizontal transfer section 1h to the output section 1d in single pixel units to output the image signal Y(t), which corresponds to a single horizontal line, after the information charges are transferred from the accumulating section 1s to the horizontal transfer section 1h. Then, the digital signal processing circuit 5 writes signal-processed image data to the line memory 8.

At timing t4, the read state signal HREF goes high when the writing of image data to the line memory 8 is completed. As the read state signal HREF goes high, the memory control circuit 7 is provided with the clock signal EXCLK from the external device, and the image data stored in the line memory 8 is read. During the period from timing t4 to timing t6, the operations performed between timing t3 and timing t4 are repetitively performed. Further, the output of the image signal Y(t) from the CCD image sensor 1 and the providing of data to the external device are performed alternately in single horizontal line units. At timing t5, the drain clock signal øb goes high, the information charges accumulated in the imaging section 1i are drained, and information charges are accumulated in the imaging section 1i until the next frame timing.

Then, at timing t6, when an interruption process is performed, the processes related to the imaging and reading operations of the external device are temporarily interrupted, and reading of data from the line memory 8 is interrupted. Thus, the data that was not read from the line memory 8 when the interruption process was performed is stored in the line memory 8 and maintained during the interruption process period until the read state signal HREF goes high.

At timing t7, when the interruption process ends, the imaging and reading operations are started again to provide the external device with the remaining data stored in the line memory 8. When the reading of data ends, the read state signal HREF goes low. The period from when the read state signal HREF goes high to when the read state signal HREF goes low after the interruption process is 130H. During this period, the determination circuit 11c performs counting and determines that the count value is greater than or equal to the determination reference value. Thus, the determination circuit 11c controls the line feed control circuit 11b to drive the horizontal transfer section 1h before the information charges are transferred from the accumulating section 1s to the horizontal transfer section 1h. At timing t8, the horizontal transfer timing signal HT (denoted by A in FIG. 5) for draining unnecessary charges goes high, and the horizontal transfer clock signal øh (denoted by A′ in FIG. 5) for draining unnecessary charges is generated in accordance with the horizontal transfer timing signal HT. The horizontal transfer clock signal øh drains unnecessary charges stored in the horizontal transfer section 1h when the imaging operation is interrupted due to the interruption process. At timing t9 after the draining of unnecessary charges is completed, the vertical transfer clock signal øv goes high, and the information charges corresponding to a single horizontal line is transferred to the reset (a state in which unnecessary charges are drained) horizontal transfer section 1h. The information charges are sequentially transferred from the horizontal transfer section 1h to the output section 1d, and the image signal Y(t) is output from the output section 1d.

In this manner, when external device requires the output of the image signal Y(t) to be interrupted and the output interruption period of the image signal Y(t) is relatively long, the horizontal transfer section 1h is driven before information charges are transferred from the accumulating section 1s to the horizontal transfer section 1h. Accordingly, the unnecessary charges produced in the horizontal transfer section 1h are prevented from affecting the reproduced image. This prevents lateral line-like noise from appearing in the reproduced screen image and improves the image quality. Further, the determination circuit 11c determines whether or not to drain unnecessary charges in accordance with the length of the period during which the output of the image signal Y(t) is interrupted. The determination drains unnecessary charges in accordance with the minimum output interruption period of the image signal Y(t). Thus, a decrease in the processing speed of the entire device that is caused by the time required for the draining process is minimized.

In the first embodiment, the horizontal transfer section 1h does not necessarily have to be driven just before information charges are transferred from the accumulating section 1s. When priority is given to improving the image quality, horizontal transfer drive for draining unnecessary charges may be performed continuously with horizontal transfer drive for outputting information charges. Alternatively, the horizontal transfer section 1h may be reset by setting the determination reference value at a value corresponding to a relatively short time. Further, when the image signal Y(t) of each line is output at constant intervals (e.g., interval of about 50H), the horizontal transfer section 1h may be reset for each line (i.e., cyclically) without employing the determination circuit 1c.

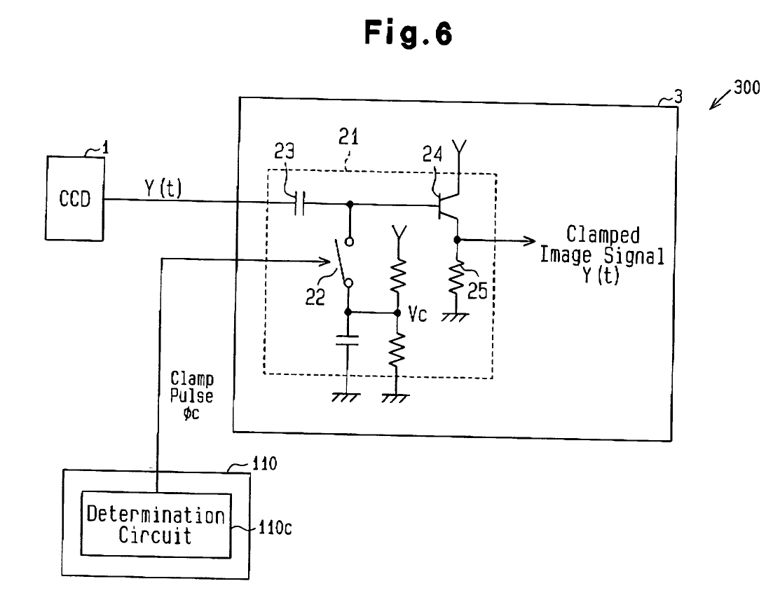

FIG. 6 is a schematic block diagram showing part of an imaging apparatus 300 according to a second embodiment of the present invention. The imaging apparatus 300 includes an analog signal processing circuit 3, which has a clamp circuit 21, and a timing control circuit 110. The clamp circuit 21 clamps the image signal Y(t) output from the CCD image sensor 1 and fixes the all-black level of the image signal corresponding to the OPB area at a predetermined voltage. The clamp circuit 21 may clamp the image signal Y′(t), which is analog signal-processed and provided to an A/D conversion circuit 4.

The clamp circuit 21 includes a switch 22, a capacitor 23, a transistor 24, and a register 25. The fluctuated amount of an image signal is retrieved by the capacitor 23. When the switch 22 is activated by a clamp pulse signal øc provided from the timing control circuit 11, the fluctuated amount is added to a clamp potential Vc. This outputs a clamped image signal Y(t) from a node between the transistor 24, which is emitter follower connected, and the register 25.

In the second embodiment, when the period during which the output of the image signal Y(t) from the CCD image sensor 1 is interrupted affects the clamp process, the clamp pulse signal øc goes high during at least part of the period from when the output of an image signal Y(t) corresponding to a single horizontal line ends to when the output of the image signal Y(t) of the next line starts. More specifically, in addition to the determination reference value for determining whether of not to drain the unnecessary charges collected on the horizontal transfer section 1h, a second determination reference value is set to determine whether or not to cause the clamp pulse signal øc to go high. The determination circuit 110c of the timing control circuit 110 determines whether or not the output interruption period of the image signal Y(t) is longer than or equal to the period represented by the second determination reference value. When the output interruption period of the image signal Y(t) is longer than or greater than the period represented by the second determination reference value, the timing control circuit 110 causes the clamp pulse signal øc to go high before the image signal Y(t) is output from the CCD image sensor 1 and prevents the clamp voltage from falling.

The clamp pulse signal øc is caused to go high for the following reasons. When the output interruption period of the image signal Y (t) is longer than the period set by the first embodiment (e.g., 500H to 1500H), the leak current of the capacitor 23 in the clamp circuit 21 or the base current of the transistor 24 decreases the voltage of the image signal to a value lower than the clamp voltage Vc. This deforms the image signal waveform and deteriorates the image quality.

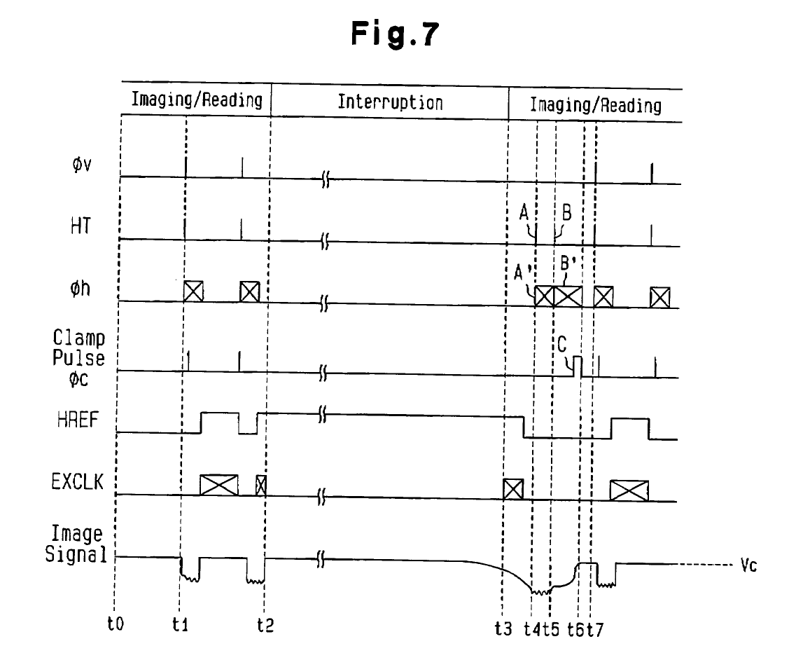

FIG. 7 is a timing chart illustrating the operation of the imaging apparatus 300 of the second embodiment. A controller, which controls the entire device including the imaging apparatus 300, monitors the imaging apparatus 300 and performs processes corresponding to the imaging and reading operations after timing t0. It is assumed here that an interruption process is performed during timing t2 to timing t3 to interrupt the reading of the image data. Further, the output interruption period of the image signal during timing t2 to timing t3 is longer than the period represented by the second determination reference value.

At timing t1, which is when the imaging operation and the reading operation are performed, the vertical transfer clock signal øv goes high, the horizontal transfer timing signal HT goes high, and the generation of the horizontal transfer clock signal øh is started. The clamp pulse signal øc goes high slightly after timing t1. The all-black level of the signal corresponding to the OPB area that is included in the image signal from the CCD image sensor 1 is clamped at a predetermined level. Then, the read state signal HREF goes high, and data is written to the line memory 8. The read state signal HREF goes low when the writing of data corresponding to a single horizontal line ends. At timing t2, the imaging operation is temporarily interrupted when the interruption process is performed. This interrupts the reading of data from the line memory 8. During the period from when the interruption process is started to when the interruption process is completed, the read state signal HREF remains high. During this period, the output of the image signal Y(t) is stopped.

At timing t3, when the interruption process ends, the imaging operation is started again to read the remaining data from the line memory 8. When the reading of the remaining data ends, the read state signal HREF goes low. When the read state signal HREF is high, the determination circuit 110c counts the horizontal synchronizing signal HD and determines whether the count value is greater than the second determination reference value. In following timing t4, the horizontal transfer clock signal øh (denoted by A′ in FIG. 7), which is used to drain the unnecessary charges collected in the horizontal transfer section 1h, is generated. The unnecessary charges stored in the horizontal transfer section 1h are drained to reset the horizontal transfer section 1h. Then, at timing t5, the horizontal transfer clock signal øh (denoted by B′ is FIG. 7) is generated again continuously from the horizontal transfer clock signal øh, which drains unnecessary charges. This drives the horizontal transfer section 1h in a state in which the horizontal transfer section 1h is empty and does not store charges. Thus, the output section 1d outputs an image signal having a level that is substantially the same as the reset level. During the period between timings t5 to t6, which is when the image signal is output, the clamp pulse signal øc (denoted by C in FIG. 7) goes high, the switch 22 of the clamp circuit 21 goes on to charge the capacitor 23, and an image signal having a level that is substantially the same as the reset level is clamped. At timing t7, the vertical transfer clock signal øv goes high, the horizontal transfer clock signal øh goes high, and information charges are transferred from the accumulating section is to the horizontal transfer section 1h. Further, information charges are transferred from the horizontal transfer section 1h to the output section 1d, and the image signal Y(t) is output from the output section Id. The clamp pulse signal øc goes high slightly after timing t7. Thus, the clamp circuit 21 clamps the image signal Y(t).

In this manner, the clamp pulse signal øc is provided to the clamp circuit 21 before the clamp circuit 21 clamps the image signal Y(t) Accordingly, the clamp circuit 21 clamps the image signal Y(t) in a state in which the output voltage of the clamp circuit 21 is maintained at the clamp potential. As a result, the clamp circuit 21 performs normal clamping on the image signal Y(t) even if the image signal Y(t) is output from the CCD image sensor 1 after a long standby state. Thus, the obtained image signal is not deformed.

It should be apparent to those skilled in the art that the present invention may be embodied in many other specific forms without departing from the spirit or scope of the invention. Particularly, it should be understood that the present invention may be embodied in the following forms.

In addition to the imaging apparatus 200, which incorporates the frame transfer CCD image sensor 1, the present invention may be applied to an imaging apparatus incorporating, for example, an interline type imaging device or a frame interline type imaging device that holds information charges corresponding to a single screen image.

The present examples and embodiments are to be considered as illustrative and not restrictive, and the invention is not to be limited to the details given herein, but may be modified within the scope and equivalence of the appended claims.

What is claimed is:

1. An imaging apparatus comprising:
a solid-state imaging device for generating an image signal in accordance with a subject image and providing the image signal to an external device, wherein the solid-state imaging device includes;
a plurality of light receiving pixels arranged in a matrix form, for accumulating information charges;
a plurality of vertical shift registers for transferring the information charges accumulated in the light receiving pixels in a vertical direction; and
a horizontal shift register for receiving the information charges from the vertical shift registers and outputting the information charges in single line units;
a drive circuit connected to the solid-state imaging device for providing the vertical shift registers with a vertical drive signal and the horizontal shift register with a horizontal drive signal to generate the image signal in the solid-state imaging device; and
a timing control circuit connected to the drive circuit for controlling the drive circuit to provide the vertical shift registers with the vertical drive signal at a constant cycle and provide the horizontal shift register with the horizontal drive signal in accordance with an output request of the image signal from the external device, wherein the timing control circuit controls the drive circuit to provide the horizontal shift register with the horizontal drive signal and to drain unnecessary charges stored in the horizontal shift register during at least part of a period in which the output of the image signal is interrupted from when the providing of the image signal that corresponds to a single line is completed to when the output request is subsequently received from the external device.

2. The imaging apparatus according to claim 1, wherein the timing control circuit measures the output interruption period of the image signal and controls the drive circuit so that the horizontal drive signal is not provided to the horizontal shift register and the draining of the charges is not performed when the output interruption period is shorter than a predetermined time.

3. The imaging apparatus according to claim 1, wherein the timing control circuit controls the drive circuit so that the information charges corresponding to a single line are transferred from the vertical shift registers to the horizontal shift register after the charges in the horizontal shift register are drained.

4. The imaging apparatus according to claim 1, wherein the drained unnecessary charges are dark current charges.

5. The imaging apparatus according to claim 1, wherein the providing of the image signal that corresponds to a single line includes a temporary interruption period during which the image signal is not provided to the external device.

6. The imaging apparatus according to claim 5, wherein the temporary interruption period of the image signal is produced when the external device performs an interruption process.

7. An imaging apparatus comprising:
a solid-state imaging device for generating an image signal in accordance with a subject image and providing the image signal to an external device, wherein the solid-state imaging device includes;
a plurality of light receiving pixels arranged in a matrix form, for accumulating information charges;
a plurality of vertical shift registers for transferring the information charges accumulated in the light receiving pixels in a vertical direction; and
a horizontal shift register for receiving the information charges from the vertical shift registers and outputting the information charges in single line units;
a drive circuit connected to the solid-state imaging device for providing the vertical shift registers with a vertical drive signal and the horizontal shift register with a horizontal drive signal to generate the image signal in the solid-state imaging device;
a timing control circuit connected to the drive circuit for controlling the drive circuit to provide the vertical shift registers with the vertical drive signal at a constant cycle and provide the horizontal shift register with the horizontal drive signal in accordance with an output request of the image signal from the external device; and
a clamp circuit for clamping the level of the image signal at a predetermined reference level;
wherein the timing control circuit controls the drive circuit to provide the horizontal shift register with the horizontal drive signal and to drain unnecessary charges stored in the horizontal shift register during at least part of a period in which the output of the image signal is interrupted from when the providing of the image signal that corresponds to a single line is completed to when the output request is subsequently received from the external device and, and the timing control circuit controls the drive circuit to further provide the horizontal shift register with the horizontal drive signal and to drive the empty horizontal shift register after draining of the charges is completed; and
wherein the clamp circuit clamps the image signal during at least part of the period in which the empty horizontal shift register is driven.

8. The imaging apparatus according to claim 7, wherein the drained unnecessary charges are dark current charges.

9. The imaging apparatus according to claim 7, wherein the providing of the image signal that corresponds to a single line includes a temporary interruption period during which the image signal is not provided to the external device.

10. The imaging apparatus according to claim 9, wherein the temporary interruption period of the image signal is produced when the external device performs an interruption process.

11. A method for driving a solid-state imaging device that generates an image signal in accordance with a subject image and provides the image signal to an external device, wherein the solid-state imaging device includes a plurality of light receiving pixels, which are arranged in a matrix form, for accumulating information charges, a plurality of vertical shift registers, and a horizontal shift register, the method comprising the steps of:
transferring the information charges accumulated in the light receiving pixels in a vertical direction by providing the vertical shift registers with a vertical drive signal at a constant cycle;
outputting the information charges transferred from the vertical shift registers in single line units by providing the horizontal shift register with a horizontal drive signal in accordance with an output request of the image signal from an external device;
generating the image signal in accordance with the information charges and providing the image signal to the external device in single line units; and
draining unnecessary charges stored in the horizontal shift register by providing the horizontal shift register with the horizontal drive signal during at least part of a period in which the output of the image signal is interrupted from when the providing of the image signal that corresponds to a single line is completed to when an output request is subsequently received from the external device.

12. The method according to claim 11, further comprising the step of:
measuring the output interruption period of the image signal, wherein the draining step is not performed when the output interruption period is shorter than a predetermined time.

13. The method according to claim 11, further comprising the step of:
transferring the information charges corresponding to a single line to the horizontal shift register after the draining step by providing the vertical shift registers with the vertical drive signal.

14. The method according to claim 11, wherein the drained unnecessary charges are dark current charges.

15. The method according to claim 11, wherein the providing of the image signal that corresponds to a single line includes a temporary interruption period during which the image signal is not provided to the external device.

16. The method according to claim 15, wherein the temporary interruption period of the image signal is produced when the external device performs an interruption process.

17. A method for driving a solid-state imaging device that generates an image signal in accordance with a subject image and provides the image signal to an external device, wherein the solid-state imaging device includes a plurality of light receiving pixels, which are arranged in a matrix form, for accumulating information charges, a plurality of vertical shift registers, and a horizontal shift register, the method comprising the steps of:
transferring the information charges accumulated in the light receiving pixels in a vertical direction by providing the vertical shift registers with a vertical drive signal at a constant cycle;
outputting the information charges transferred from the vertical shift registers in single line units by providing the horizontal shift register with a horizontal drive signal in accordance with an output request of the image signal from an external device;
generating the image signal in accordance with the information charges and providing the image signal to the external device in single line units;
draining unnecessary charges stored in the horizontal shift register by providing the horizontal shift register with the horizontal drive signal during at least part of a period in which the output of the image signal is interrupted from when the providing of the image signal that corresponds to a single line is completed to when an output request is subsequently received from the external device;
driving the empty horizontal shift register after the draining step by providing the horizontal shift register with the horizontal drive signal; and
clamping the level of the image signal at a predetermined reference level during at least part of the period in which the empty horizontal shift register is driven.

18. The method according to claim 17, wherein the drained unnecessary charges are dark current charges.

19. The method according to claim 17, wherein the providing of the image signal that corresponds to a single line includes a temporary interruption period during which the image signal is not provided to the external device.

20. The method according to claim 19, wherein the temporary interruption period of the image signal is produced when the external device performs an interruption process.
